(19) United States
(12) Patent Application Publication
(10) Pub. No.: US 2009/0272328 A1
(43) Pub. Date: Nov. 5, 2009

(54) Uses of Amino Acid and Amino Acid Supplements Thereof

(75) Inventor: Andre Vosloo, Potchefstroom (ZA)

Correspondence Address: SCHWEGMAN, LUNDBERG & WOESSNER, P.A., P.O. BOX 2938, MINNEAPOLIS, MN, 55402, US

(73) Assignee: North-West University, Potchefstroom (ZA)

(21) Appl. No.: 11/992,205

(22) PCT Filed: Sep. 19, 2006
(86) PCT No.: PCT/IB2006/053354

§ 371 Date: Mar. 18, 2008

(30) Foreign Application Priority Data
Sep. 20, 2005 (ZA) 2005/07601

(51) Int. Cl. A01K 63/02; A01K 61/00; A23K 1/16

(52) U.S. Cl. 119/201; 119/242; 426/648

(57) ABSTRACT

This invention relates to the use of free L-proline in the preparation of a supplement, and to a supplement so prepared, as well as a method using such a supplement for supplementing the concentration of cellular free L-proline in abalone and for restricting the dehydration of abalone. The supplement is further effective in reducing the levels of free radicals in abalone experiencing water stress and hypoxic stress. The invention further relates to a method of restricting the dehydration of abalone during storage and transportation including the step of administering to abalone an effective amount of free L-proline.

### INTRODUCTION AND BACKGROUND

This invention relates to uses of an amino acid and amino acid supplements thereof. This invention further relates to a feed and anti-dehydrating supplement for abalone including such an amino acid.

South African abalone (Haliotis midae) is successfully farmed commercially in land based on-growing systems in South Africa. Investment in the South African abalone farming industry is in excess of R80 million and is driven by a seemingly insatiable foreign market and the favourable exchange rates enjoyed by exporters.

The current yield from the 11 largest commercial farms amounts to about 780 tons per year, with the bulk being destined for the Far Eastern market. At USD37 per kilogram (including the shell) this corresponds to foreign income of almost R 200 million per year. Apart from the huge foreign revenue, an additional advantage of farmed abalone is that it relieves pressure on limited and slow-growing natural communities that are being stripped by poachers.

However, South Africa is not the only producer of cultured abalone and increased competition in this market sector is placing pressure on the industry to become more competitive in terms of lowering production costs and increasing product quality and yield.

The effects of animal health, growth stage and physiological condition on production quality and yield have long been recognised in conventional animal husbandry systems. Abalone is no different. Experience over the past few years has clearly shown that the condition of the abalone affects the final product, both during live transport and canning. Problems have been experienced with mortalities, excessive mass loss during live exports, lowered yields and inferior flesh quality on canning. This impacts on individual producers and is detrimental to the market for South African abalone as a whole.

During live exports, abalone is transported by air, in air-filled polystyrene containers. During the (up to) 40 hours of aerial exposure, animals lose on average 15% of their body mass as water. The two main water loss routes are via evaporative water loss and mucus production. As farmers are paid on landed mass, this corresponds to a 15% loss of foreign income which, based on the figures above, amounts to losses of almost R30 million per year.

Water is an essential molecule for sustaining life and an animal's ability to cope with changes in its internal water content is paramount for its survival. Loss of internal water is a threat common to all animals. Such losses could occur through evaporation, waste excretion, mucus production or osmosis. Osmosis usually occurs in a saline environment, such as sea water, or by extra-cellular freezing. As a result of water loss and hypoxia during the transport process, levels of intracellular free radicals increase, causing damage to the cells.

There are two main categories into which organisms are divided in terms of their adaptations to water stress namely osmoconformers and osmoregulators. Osmoconformers usually use organic osmolytes, such as amino acids, to keep cellular osmotic pressure equal to that of the external fluid environment. Osmoregulators use ion transport to regulate internal osmotic pressure homeostatically. Osmoconformers are most commonly found in the oceans and include most types of life other than most vertebrates and some arthropods. Abalone is an osmoconformer and accumulates relatively higher levels of osmolytes, such as L-proline, when experiencing water stress. Abalone possesses only limited osmoregulatory capabilities, thus the effects of salinity fluctuations directly influence the internal ionic balance. It has been shown previously that dietary history can directly affect resistance to low salinity in abalone.

It is known that most research on L-proline as osmolyte pertains to its role in freshwater animals. It has been shown that the concentration of L-proline increases when freshwater and brackish water animals are exposed to hyperosmotic stress. Some examples include prawns, mussels, clams, mayflies and mosquito larvae.

Very few references are available on marine animals, like abalone. Only one reference was found pertaining to the role of L-proline in abalone. It is known that L-proline is released from the cells of Australian abalone (Haliotis roel) to maintain cell volume at low salinities. The most important amino acids for cell volume regulation in abalone appear to be taurine, glycine, alanine and L-proline with an emphasis on taurine.

The above examples demonstrate why amino acids in general (including L-proline) are considered as intracellular osmolytes of animal cells. These compounds can be accumulated or released to maintain osmotic concentration without adversely affecting cellular function.

The following is also known:
proline and betaine are not very effective antioxidants in plant cells, when compared to cyclitols and polyols (e.g. mannitol);
L-proline is used for water retention in plant cells;
L-proline may aid in maintaining redox balance in water stressed plant cells; and
Some of these solutes (osmolytes), especially taurine and sometimes inositol and glycine betaine, are major ingredients of a number of energy or sports drinks. No reference is made to L-proline in this regard.

In light of the above, it is well studied and accepted as fact that L-proline plays a key role in the maintenance of osmotic balance in cells.

JP01215248A2 discloses the use of free L-proline in artificial compounded fish feed for enhancing the vitality, survival ratio and growth of cultured fish. However, no reference to the use of free L-proline as a feed supplement effective as an anti-dehydrating agent and anti-oxidant could be found.

### OBJECTS OF THE PRESENT INVENTION

It is accordingly an object of the present invention to provide a supplement for abalone with which the aforesaid disadvantages experienced in the transport of live abalone could be alleviated. In particular, it is an object to provide an anti-dehydrating and anti-oxidant agent and supplement for limiting the dehydration of live abalone and for reducing the levels of free-radicals in live abalone, particularly those experiencing water stress.

### SUMMARY OF THE INVENTION

According to a first aspect of the invention there is provided use of free L-proline in the preparation of a supplement for supplementing the concentration of cellular free L-proline in abalone and for restricting the dehydration of abalone.

According to a second aspect of the invention there is provided use of free L-proline as a supplement for supplementing the concentration of cellular free L-proline in abalone and for restricting the dehydration of abalone.

According to a third aspect of the invention there is provided a supplement for supplementing the concentration of cellular free L-proline in abalone and for restricting the dehydration of abalone, the supplement comprising an effective amount of free L-proline.

The above supplement may further be effective in reducing the levels of free radicals in abalone experiencing water stress and hypoxic stress.

According to a fourth aspect of the invention there is provided a method of supplementing the concentration of cellular free L-proline in abalone and for restricting the dehydration of abalone including the step of administering to abalone an effective amount of free L-proline.

According to a fifth aspect of the invention there is provided a method of restricting the dehydration of abalone during storage and transportation including the step of administering to abalone an effective amount of free L-proline.

An effective amount of L-proline may be between 50 and 200 g, preferably 100 g free L-proline, per between 2 and 20 kg, preferably 10 kg dry mass of feed, with between 10 and 100 g, preferably 50 g dry feed being fed to between 2 and 20, preferably 10 kg live abalone every 1 to 6, preferably 3 days.

### BRIEF DESCRIPTION OF THE DIAGRAMS

The invention will now be described further, by way of example only, inter alia with reference to the accompanying diagrams wherein:

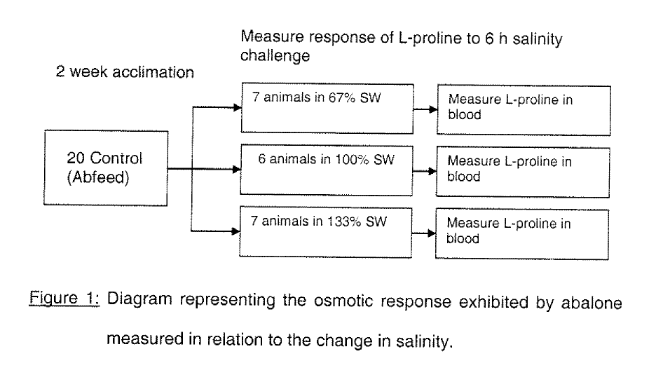

FIG. 1 is a diagram representing the experimental design to test the osmotic response of abalone measured in relation to the change in salinity;

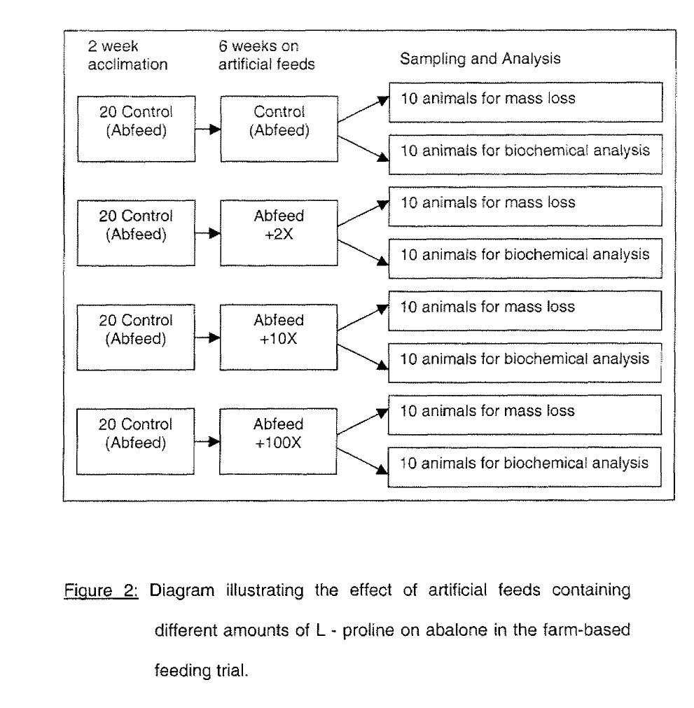

FIG. 2 is a diagram illustrating the experimental design to test the effect of artificial feeds containing different amounts of free L-proline on abalone in the farm-based feeding trial;

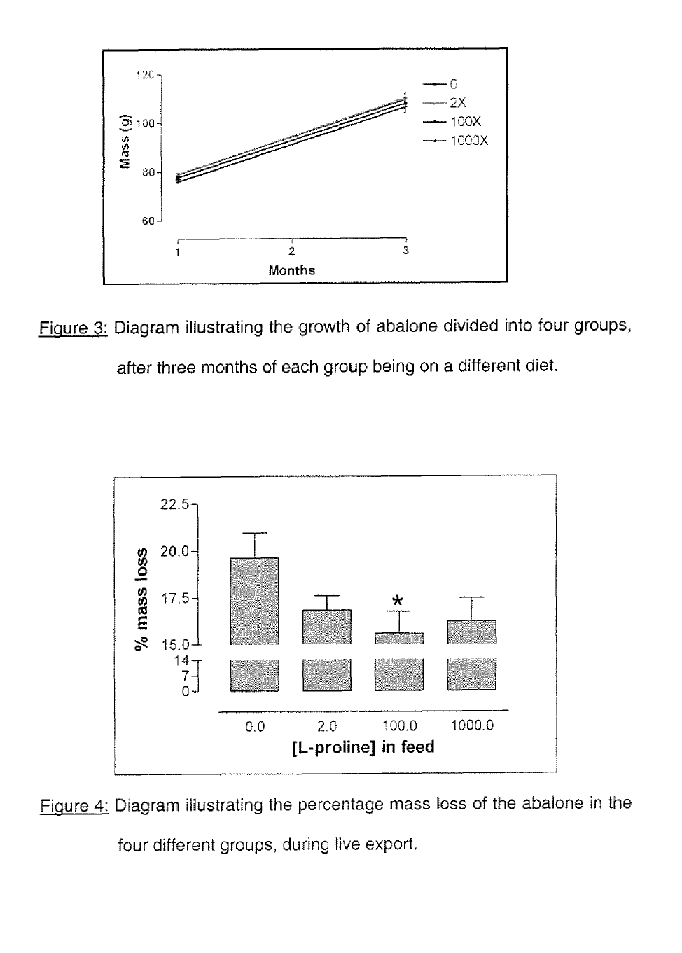

FIG. 3 is a diagram illustrating the growth of abalone divided into four groups, after three months of each group being on a different diet;

FIG. 4 is a diagram illustrating the percentage mass loss of the abalone in the four different groups, during live export;

FIG. 5 is a diagram illustrating the percentage mass loss of abalone during live export relative to a control group;

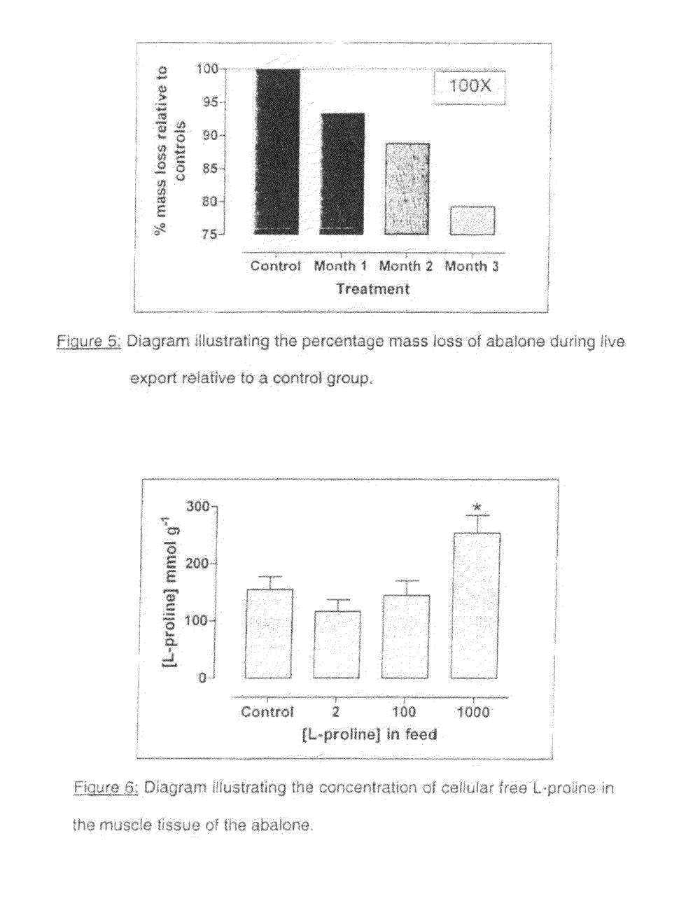

FIG. 6 is a diagram illustrating the concentration of cellular free L-proline in the muscle tissue of the abalone;

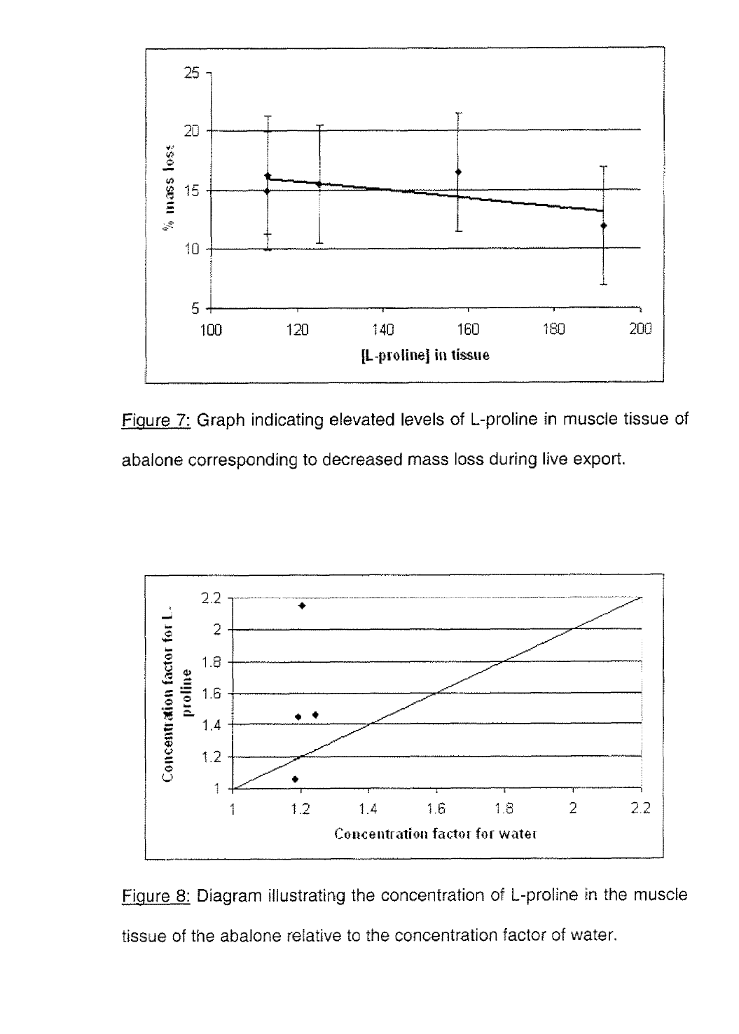

FIG. 7 is a diagram illustrating the levels of L-proline in the muscle tissue of abalone relative to decreased mass loss during live export;

FIG. 8 is a diagram illustrating the concentration of L-proline in the muscle tissue of the abalone relative to the concentration factor of water;

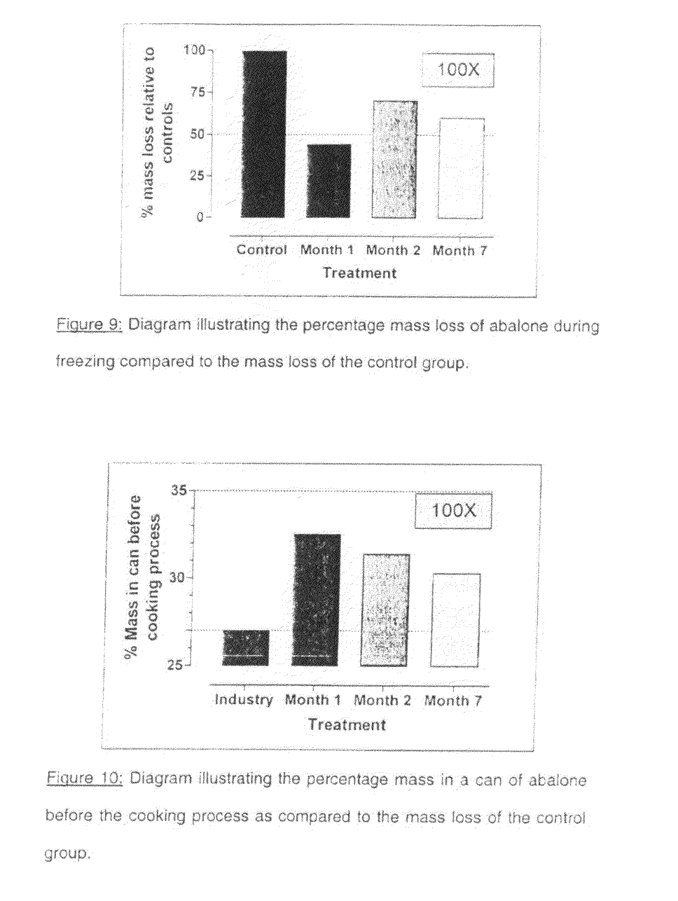

FIG. 9 is a diagram illustrating the percentage mass loss of abalone during freezing compared to the mass loss of the control group;

FIG. 10 is a diagram illustrating the percentage mass in a can of abalone before the cooking process as compared to the mass loss of the control group;

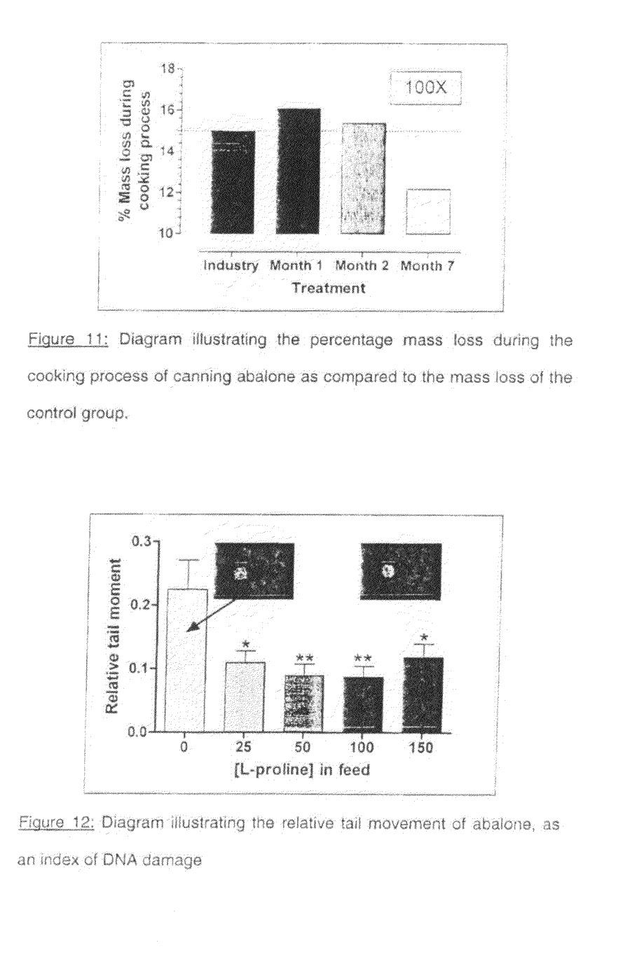

FIG. 11 is a diagram illustrating the percentage mass loss during the cooking process of canned abalone as compared to the mass loss of the control group;

FIG. 12 is a diagram illustrating the relative tail moment of abalone haemolymph cells, as an index of DNA damage; and

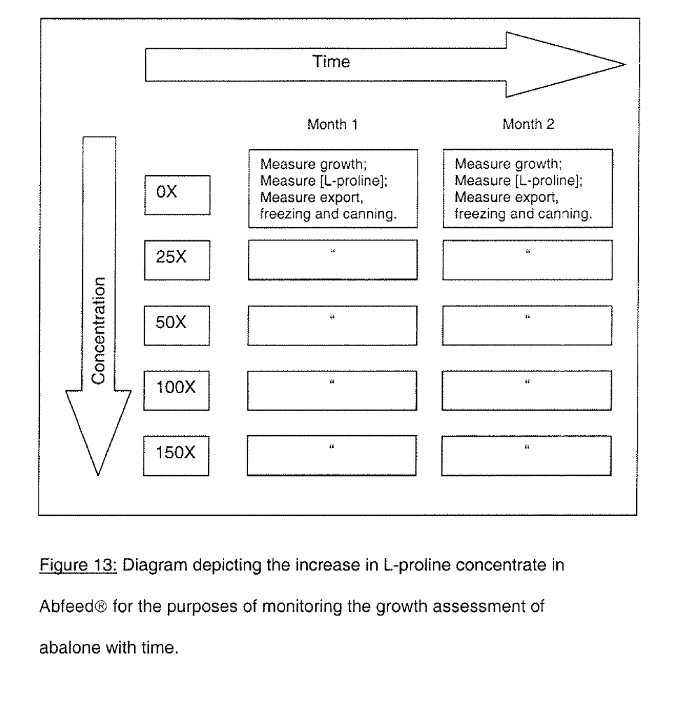

FIG. 13 is a diagram depicting the increase in L-proline concentrate in Abfeed® for the purposes of monitoring the growth assessment of abalone with time.

### DESCRIPTION OF PREFERRED EMBODIMENTS OF THE INVENTION

The applicant has investigated methods and supplements for overcoming the dehydration of abalone in transport. In particular, the applicant investigated the effect of the increased deposition of free L-proline in the muscle tissues of abalone on their water retention during the desiccating live export process. In addition, the applicant investigated the formulation of a supplement containing free L-proline and the application of the supplement as a feed for abalone in a mixture with the current abalone artificial food of choice, namely Abfeed®.

### Method

Holding system

Animals were held at 16° C. in a flow-through system in a laboratory or at farm conditions during the farm based trial.

### Experiment to Determine Whether Abalone Exhibits an Osmotic Response in Free L-Proline

The first step was to ascertain that abalone do indeed use L-proline to cope with osmotic insult. In this experiment a control group of animals was kept in full strength (100%) seawater, the second group was kept in dilute seawater (67% SW) and the third was kept in concentrated seawater (133%) (FIG. 1). Blood was drawn from the pallial sinus, and compound L-proline was quantified in all three groups.

Experiment to Determine Whether the Uptake of Free L-Proline from Enhanced Feeds Offers Mass Loss Advantages

Three batches of Abfeed® were produced with graded amounts of free L-proline. The three formulations, with standard Abfeed® as control, were fed to four groups of abalone in the export size class (approximately 100 g animals). Eighty animals were split into the four feeding groups. Farm-bred animals were obtained commercially.

At the end of the fourteen-week period (two weeks acclimation on standard Abfeed® and twelve weeks on the formulations), ten individually weighed animals from each group were subjected to a simulated export (36 hours in vapour saturated air at 12° C.) and mass loss recorded relative to the initial mass. The other 10 animals from each group were snap-frozen in liquid nitrogen for quantification of free L-proline in the hemolymph and muscle tissue.

### Water Quality

The ionic composition of seawater was monitored on a daily basis (ICP-MS after 10,000× dilution and acidification) in order to adjust for optimal concentrations. Ammonia, nitrate and nitrite were monitored weekly to check functioning of the filter systems.

### Statistical Analysis

Differences in mass loss were correlated to the feeding groups and final tissue levels of the active ingredient.

### EXAMPLE

Abalone were divided into four different groups of which one group was a control group being fed standard Abfeed®. The other three groups were fed Abfeed®enhanced with differential amounts of L-proline. The four groups of abalone were utilised in a farm-based feeding trial. A commercial abalone farmer provided approximately 1000 animals for the trials. As no previous studies could be drawn on, exponentially different concentrations of L-proline were chosen.

FIG. 3 depicts the growth of the 4 groups of animals after 3 months on the different diets. Animals were weighed and measured prior to the start of the feeding trials as well as at the end of the trials. There was no significant difference in growth between the different groups, indicating that the Abfeed® enhanced with L-proline did not have a negative impact on the growth of the animals and that enhanced feeds are palatable and readily taken by the animals. At the start of the first month there were 120 animals per group and at the end of the third month there were 30 animals per group.

At the end of the 3 month feeding trial, 10 animals from each group were shucked and sampled for muscle tissue and haemolymph. Samples were snap-frozen in liquid nitrogen on site, transported in liquid nitrogen and transferred to an −80° C. freezer.

Twenty individually weighed animals from each group were prepared for live export as per normal purging protocol, packed and flown to Johannesburg International Airport. The box was opened exactly 36 h after sealing to simulate the worst case live export scenario, and all animals were individually re-weighed to calculate percentage mass loss during live export.

The percentage mass loss for the four groups is shown in FIG. 4. An unpaired t-test between control and 100× indicated a highly significant improvement (P=0.0275) in mass loss performance. This represents a 20% improvement in mass loss relative to the control animals. A 20% export performance improvement could mean a substantial annual increase in income for the industry.

An L-proline concentration of between 2× and 100× appears to offer the best export performance enhancement, with saturation being evident at 1000×.

The effect of feeding time was investigated by sampling animals from different feeds, after 1, 2, and 3 months. As shown in FIG. 5, it is clear that the most benefit accrued after 3 months on Abfeed® enhanced with 100 g L-proline per 10 kg dry feed (10 g/kg, 1%, 0.3 g L-proline per day).

In order to demonstrate that the enhanced feeds enhance free L-proline in the muscle tissues of the animals, muscle tissue was analysed for free L-proline in all groups and at different feeding times. After 3 months on feeds enhanced with L-proline, free L-proline concentrations in tissue of the animals increased significantly, as shown in FIG. 6. As depicted in FIG. 6, only highly enhanced L-proline in feeds resulted in significant free L-proline in the muscle tissue of the animals. At lower levels of feed enhancement, free L-proline is well regulated.

FIG. 7 shows a relationship between free L-proline in the muscle tissue of the animals and the concomitant percentage mass loss for each group of animals during live export. It is evident that there is a correlation between tissue L-proline and reduced mass loss. The large correlation coefficient (R²=0.4624) indicates that high tissue L-proline levels would lead to decreased mass loss during live export of the animals.

No significant differences could be demonstrated between the water content of the animals on the different feed formulations. The action of L-proline as an osmolyte is therefore not to enhance the water content of the animals. The function of L-proline is only apparent under conditions of osmotic stress, or example, during live export of the animals. The observed decrease in mass during live export is ascribed in total to loss of body water. This would result in a concentration of ions and amino acids by a factor of approximately 1.2. Howvever, in exported animals, L-proline is concentrated by a factor of 1.4 or more, as shown in FIG. 8, which indicates that a release from sources other than free L-proline, for example, proteins with a larger L-proline content.

Two additional products that may benefit from this work have been identified, namely canning and freezing. Both the canned and frozen abalone products are very popular in the Far East. Both processes are inefficient due to the amount of fluid loss incurred during production. It is estimated that only 40 g of every 100 g of living abalone mass ends up in the can. Improving the osmotic potential of abalone by L-proline-enhanced feeds provides improvement in these processes.

FIG. 9 shows the mass loss of the animals during freezing on 100 g L-proline per 10 kg dry feed. The graph depicts the decreased water loss of animals on enhanced feed relative to the mass loss of the control group of animals. After one month, enhanced performance in the animals on the enhanced feed is apparent.

FIG. 10 shows the percentage mass in the can of abalone before the cooking process as compared to the mass loss of the control group. The animals on a diet of 100 g L-proline per 10 kg dry feed yielded an increase in the mass of the flesh of the animals (from 27% to 30%).

FIG. 11 shows the percentage mass loss during the cooking process of canning abalone as compared to the mass loss of the control group, being the current industry standard. An improved yield was evident after at least three months.

FIG. 12 depicts a further advantage of animals fed with L-proline enhanced feed, being anti-oxidant protection. The ability of L-proline to protect the animal cells against free-radical damage was measured. Free-radical damage is expected to occur during oxidative stress of the live export process. After export, haemolymph cells from the animals were subjected to COMET analysis and the relative tail moment was measured. The DNA damage (as measured by the relative tail moment) was significantly less in the animals on the enhanced L-proline diet. It is therefore foreseen that a diet consisting on L-proline enhanced feeds could lead to limited oxidative damage in abalone during bouts of hypoxia, hyperoxia and frequent handling.

The current effective concentration range has been determined as from 2 to 100× increase in L-proline uptake.

Four feed formulations were produced, with the normal Abfeed® formulation as a control, and three normal Abfeed® formulations enhanced with 2, 100 and 1000 g of L-proline per 10 kg batch of Abfeed®. Four baskets of abalone (on average 80 g, or 2 months from export size) were used as per normal farm stocking density, and maintained as per normal farm protocols.

Thirty animals in each basket were marked and weighed for controlled growth assessment: at the start of the trials, after 1 month and again after 2 months. The increase in L-proline concentrate in Abfeed® for the purposes of monitoring the growth of abalone with time is shown in FIG. 13.

At T₁ and T₂, 10 animals from each group were sampled for L-proline content.

At T₁ and T₂, 20 individually weighed animals from each group were exported as per standard farm protocol to North-West University and re-weighed after 36 h to measure the extent of water loss incurred by each group.

These trials indicated that the optimum L-proline concentrate in the Abfeed® amounts to 100 g L-proline per 10 kg dry mass abalone feed, with 50 g dry mass abalone feed being applied to 10 kg abalone every third day.

The applicant has surprisingly found that enhancing Abfeed® with free L-proline leads to decreased mass loss during live exports. Most effective reduction in mass loss occurs after 3 months. Furthermore, it has been shown that Abfeed® enhanced with 100 g L-proline per 10 kg dry feed, fed to abalone over a period of 3 months, is readily taken by the animals and does not negatively affect the growth of the animals.

The finding that free L-proline is effective as a hydrating agent required intuitive leaps based on the fact that cells under osmotic stress accumulate L-proline to maintain cell volume, by drawing water back into cells along an osmotic gradient. As far as could be ascertained, L-proline has not yet been implicated as an external supplement that would prevent or limit water loss from abalone experiencing water stress such as when being transported.

It will be appreciated that variations in detail are possible with the present invention without departing from the scope of the appended claims.

1. Use of free L-proline in the preparation of a supplement for supplementing the concentration of cellular free L-proline in abalone and for restricting the dehydration of abalone.

2. Use of free L-proline as a supplement for supplementing the concentration of cellular free L-proline in abalone and for restricting the dehydration of abalone.

3. A supplement for supplementing the concentration of cellular free L-proline in abalone and for restricting the dehydration of abalone, the supplement comprising an effective amount of free L-proline.

4. A supplement according to claim 3 which reduces the levels of free radicals in abalone experiencing water stress and hypoxic stress.

5. A method of supplementing the concentration of cellular free L-proline in abalone and for restricting the dehydration of abalone including the step of administering to abalone an effective amount of free L-proline.

6. A method of restricting the dehydration of abalone during storage and transportation including the step of administering to abalone an effective amount of free L-proline.

7. A method of restricting the dehydration of abalone according to claim 6 wherein an effective amount of L-proline is between 50 and 200 g free L-proline, per between 2 and 20 kg dry mass of feed, with between 10 and 100 g dry feed being fed to between 2 and 20 kg, live abalone every 1 to 6 days.

8. A method of restricting the dehydration of abalone according to claim 7 wherein an effective amount of L-proline is 100 g free L-proline, per 10 kg dry mass of feed, with 50 g dry feed being fed to 10 kg, live abalone every 3 days.

9. Use of free L-proline in the preparation of a supplement substantially as herein described and exemplified.

10. Use of free L-proline as a supplement substantially as herein described and exemplified and with reference to the accompanying figures.

11. A supplement substantially as herein described and exemplified.

12. A method of supplementing the concentration of cellular free L-proline substantially as herein described and exemplified.

13. A method of restricting the dehydration of abalone substantially as herein described and exemplified and with reference to the accompanying figures.
